(19) United States
(12) Patent Application Publication
(10) Pub. No.: US 2004/0218036 A1
(43) Pub. Date: Nov. 4, 2004

(54) System and method for managing public and private information

(76) Inventors: Scott D. Boss, Portland, OR (US); Antonio T. Latto, Portland, OR (US); Ryan S. Russell, Hillsboro, OR (US); James Okuley, Portland, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/426,120

(22) Filed: Apr. 29, 2003

(51) Int. Cl. H04N 7/14

(52) U.S. Cl. 348/14.08; 348/14.07

(57) ABSTRACT

A system and method for managing public and private information displayed on a user's computer screen by hiding the private information and displaying the public information to others on a secondary display. In one embodiment, a user may select an area of the user's computer screen to be viewed by an audience on the secondary display. The selected area is then copied to a separate location. The separate location is then rendered to the secondary display to be viewed by the audience. The secondary display only contains public information from the user's computer display.

### BACKGROUND OF THE INVENTION

1. Field of the Invention

The present invention is generally related to the field of data management. More particularly, the present invention is related to a system and method for managing public and private information.

2. Description

Currently, when a user wishes to display information on their computer screen via a projector, their entire screen is shown for the audience to view. In many instances, the user wants the audience to be able to view a specific area of the computer screen or a specific application instead of the entire screen. For example, when a user attaches the computer to a projector, private information on the user's computer screen that the user does not want the audience to view may be displayed along with public information that the user wants the audience to view. Such private information may include, but is not limited to, emails, documents, applications, or notes related to a presentation to be given by the user. The public information may be, for example, the presentation to be given by the user.

Thus, what is needed is a system and method for enabling a user to display only those portions of the user's computer screen that the user desires to be viewed by the audience. What is further needed is a system and method for enabling a user to manage private and public information displayed on the user's computer screen, where the public information may be viewed by an audience via a second display device and the private information may be hidden from the audience, only to be viewed by the user on the user's computer screen.

### BRIEF DESCRIPTION OF THE DRAWINGS

The accompanying drawings, which are incorporated herein and form part of the specification, illustrate embodiments of the present invention and, together with the description, further serve to explain the principles of the invention and to enable a person skilled in the pertinent art(s) to make and use the invention. In the drawings, like reference numbers generally indicate identical, functionally similar, and/or structurally similar elements. The drawing in which an element first appears is indicated by the leftmost digit(s) in the corresponding reference number.

FIG. 1 is a diagram illustrating a typical projector display in which both public and private information from a user's computer screen are displayed to an audience.

FIG. 2 is a block diagram illustrating an exemplary system for managing public and private information from a user's computer screen for display of the public information to others on a secondary display according to an embodiment of the present invention.

FIG. 3 is a block diagram illustrating a graphical user interface for managing public and private information on a user's computer screen for display of the public information to others on a secondary display according to an embodiment of the present invention.

FIG. 4 is a flow diagram describing an exemplary method for managing public and private information on a user's computer screen for display of the public information to others on a secondary display according to an embodiment of the present invention.

FIG. 5 is a block diagram illustrating an exemplary separate location for viewing selected public information in a system for managing public and private information from a user's computer screen for display of the public information to others on a secondary display according to an embodiment of the present invention.

FIG. 6 is a flow diagram describing an alternative exemplary method for managing public and private information on a user's computer screen for display of the public information to others on a secondary display according to an embodiment of the present invention.

FIG. 7 is a block diagram illustrating an exemplary system for managing public and private information on a user's computer screen for display of the public information to others over a network connection on a plurality of secondary displays according to an embodiment of the present invention.

FIG. 8 is a flow diagram further describing an exemplary selection method for managing public and private information on a user's computer screen for display of the public information to others on a secondary display according to an embodiment of the present invention.

FIG. 9 is a block diagram illustrating an exemplary computer system in which certain aspects of embodiments of the present invention may be implemented.

### DETAILED DESCRIPTION

While the present invention is described herein with reference to illustrative embodiments for particular applications, it should be understood that the invention is not limited thereto. Those skilled in the relevant art(s) with access to the teachings provided herein will recognize additional modifications, applications, and embodiments within the scope thereof and additional fields in which embodiments of the present invention would be of significant utility.

Reference in the specification to “one embodiment”, “an embodiment” or “another embodiment” of the present invention means that a particular feature, structure or characteristic described in connection with the embodiment is included in at least one embodiment of the present invention. Thus, the appearances of the phrase “in one embodiment” appearing in various places throughout the specification are not necessarily all referring to the same embodiment.

Embodiments of the present invention are directed to systems and methods for managing public and private information on a user's computer screen by hiding the private information and displaying the public information to others on a secondary display. Although embodiments of the present invention are described with respect to the secondary display being a projector screen, embodiments of the invention may be applied to any secondary display, such as other computer monitors, projection television displays, LCDs (liquid crystal displays) and plasma monitors, etc.

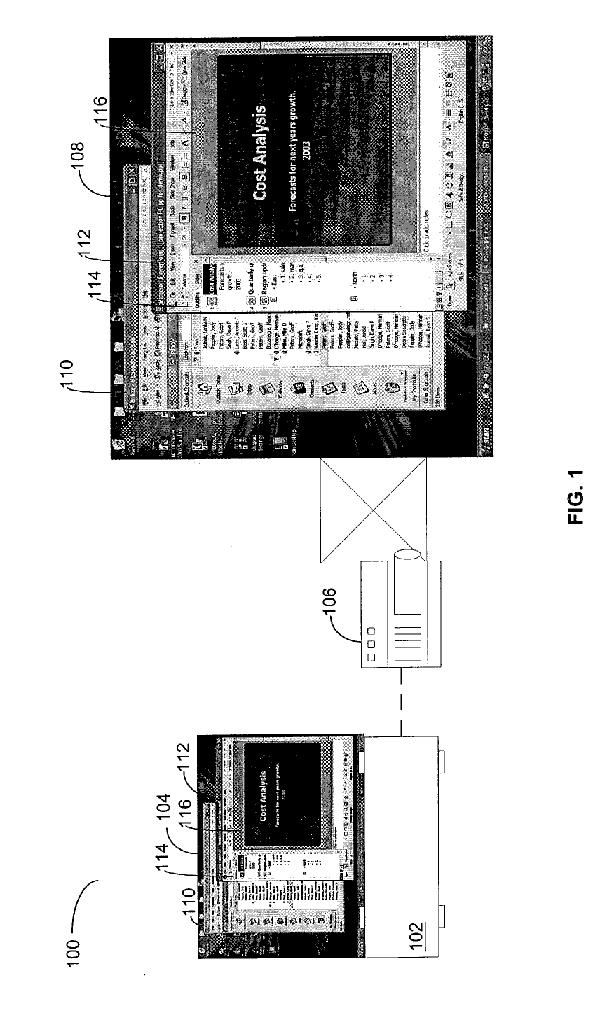

FIG. 1 is an exemplary diagram 100 illustrating a typical projector display in which both public and private information from a user's computer screen are displayed to an audience. Diagram 100 shows a desktop computer (or laptop) 102 having a computer screen 104, a projector 106, and a projector screen 108. Computer 102 may be coupled to projector 106 using a serial cable, a universal serial bus (USB) cable, an infrared (IR) port, Ethernet, wireless Ethernet, Bluetooth, or any other means for coupling a computer to projector 106 for the transfer of data.

Computer screen 104 displays examples of both private and public information. Private information refers to information displayed on computer screen 104 that the user does not want to share with the public. In other words, private information is information that should be privy to only the user. On the other hand, public information refers to information displayed on computer screen 104 that the user wishes to share with the public.

Exemplary private information shown on computer screen 104 comprises a Microsoft® Outlook® Inbox window 110 and a Microsoft® PowerPoint® window 112, both by Microsoft Corporation. Private information shown in Microsoft® Outlook® Inbox window 110 includes a list of emails delivered to the user. Private information shown in Microsoft® PowerPoint® window 112 includes an outline 114 of a PowerPoint presentation that the user is to present. Outline 114 includes notes about the presentation that the user or presenter may not want the audience to view. The user may not want the audience to view the email listing as well. Exemplary public information shown on computer screen 104 comprises a PowerPoint presentation 116. PowerPoint presentation 116 lies within Microsoft® PowerPoint® window 112.

Projector 106 is an instrument having a lens that is used to cast or project images onto a screen, such as projector screen 108. With the configuration shown in FIG. 1, when the user wishes to display public information from computer screen 104 via projector 106, both private and public information are displayed to the audience on projector screen 108.

Embodiments of the present invention are directed toward systems and methods for managing public and private information on a user's computer screen for display of the public information to others. This is accomplished by incorporating an interface that enables the user to select an area of the computer screen that the user wishes to display to an audience. The selected area is copied to a separate location. Information within the separate location is then shown externally as a full screen display on a secondary monitor or screen. Thus, the ability to select the data to be projected to the public rather than displaying the user's entire desktop gives the user complete control over what is displayed from computer screen 104 on a secondary display for public consumption by the audience.

Embodiments of the present invention increase the usability of computer 102 by allowing the user to select what is displayed rather than always displaying the user's entire desktop. This gives the user more flexibility to perform other tasks on computer 102 that are hidden from the audience while displaying public information to the audience on a secondary display. For example, the user may review electronic mail in private while displaying a presentation on the secondary display. In another example, the user may edit other documents that are hidden from the audience while the audience views public information from the user's primary display on a secondary display.

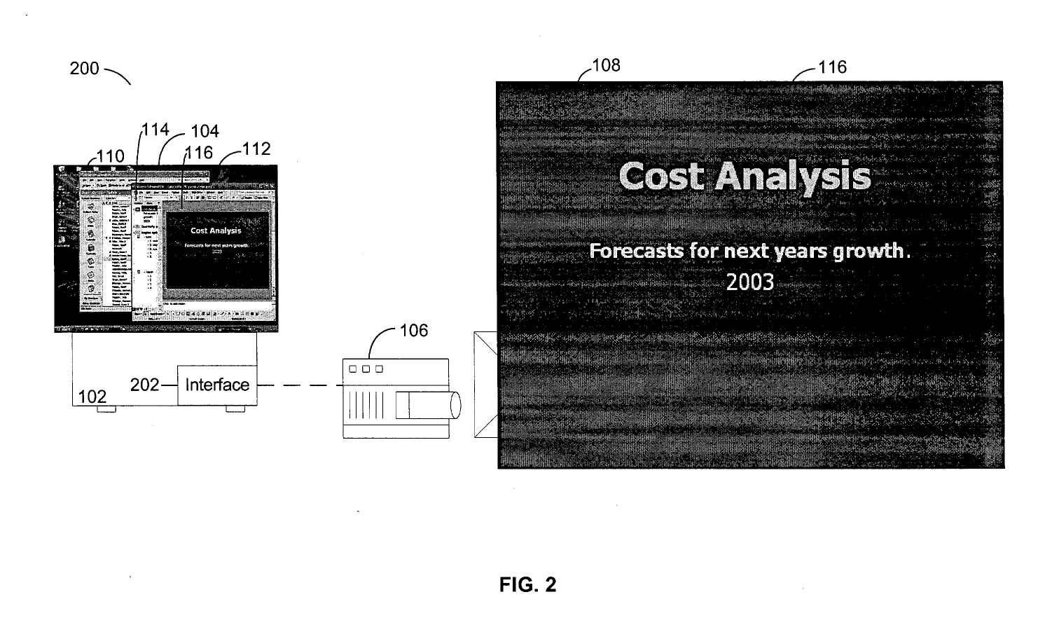

FIG. 2 is a block diagram illustrating a system 200 for managing public and private information on a user's computer screen for display of the public information to others on a secondary display according to an embodiment of the present invention. System 200 comprises desktop computer 102 with computer screen 104, an interface 202, projector 106, and projector screen 108. Interface 202 is shown interior to desktop computer 102 and may be implemented in software, hardware, or a combination thereof. Although embodiments of the present invention show interface 202 as being located interior to desktop computer 102, interface 202 may also be located exterior to desktop computer 102. Interface 202 is used to enable a user to select information on computer screen 104 for public display on projector screen 108 via projector 106. As shown in FIG. 2, with the use of interface 202, only public information (i.e., PowerPoint presentation 116) is shown on projector screen 108.

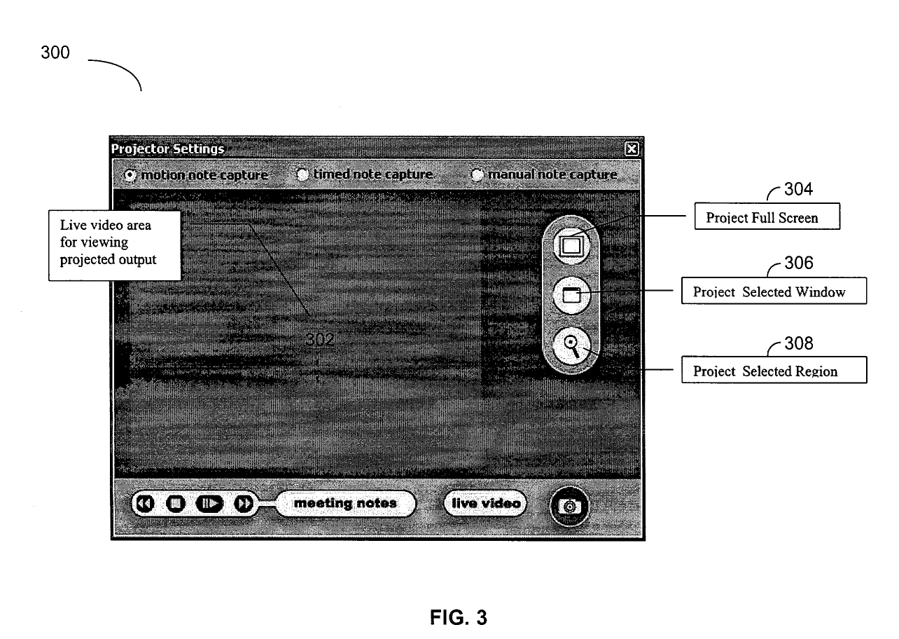

In an embodiment of the present invention, interface 202 is comprised of software running on desktop computer 102. The software may include a graphical user interface, such as graphical user interface 300 shown in FIG. 3. Graphical user interface 300 provides three modes that allow for the segmentation of private and public information on a primary screen for viewing of the public information on a secondary display. Graphical user interface 300 provides a separate location for displaying the public information selected by the user for public consumption via the secondary display. Graphical user interface 300 comprises, inter alia, a display area 302, and three buttons 304, 306, and 308 for selecting portions of a primary display for viewing on a secondary display. The primary display may be, but is not limited to, the user's desktop computer monitor or laptop computer monitor, such as computer screen 104. The secondary display may be, but is not limited to, a projector screen, another desktop or laptop computer monitor, a projection television, or any other display means.

Display area 302 may be used to view those portions of the primary display that are selected by one of buttons 304, 306, and/or 308 for viewing on the secondary display. In one embodiment, display area 302 may be used to enable the user to view the public information selected by the user for public consumption. In another embodiment, display area 302 may be used to display live video from a camera (not shown) that is focused on the secondary display (e.g., projector screen 108). In this instance, the user is viewing an image of the display presented on the secondary display and another location is used for enabling the user to view the public information selected by the user using one of buttons 304, 306, and/or 308. In yet another embodiment of the invention, the public information selected by the user using one of buttons 304, 306, and/or 308 may be viewed by the user in a location other than display area 302. Such locations may include, but are not limited to, a location on a screen, a memory location, a location on a disk drive, etc.

Button 304 is a desktop capture mode button. Desktop capture mode button 304 enables the user to display the entire desktop from the primary screen for display on the secondary screen. For example, in FIG. 2, if desktop capture mode button 304 were selected, the image seen on projection screen 108 would be identical to computer screen 104.

Button 306 is a window capture mode button. Window capture mode button 306 enables the user to select a window on the desktop from the primary screen for display on the secondary screen. For example, in FIG. 2, if window capture mode button 306 were selected, any one of, or both of, windows 110 and 112 displayed from primary screen 104 may be selected for viewing on secondary screen 108.

Button 308 is a region capture mode button. Region capture mode button 308 enables the user to drag a bounding box on a desktop to capture a region of the desktop in the primary display for viewing on the secondary display. For example, in FIG. 2, region capture mode button 308 was selected to capture PowerPoint presentation 116 in primary screen 104 for viewing on secondary screen 108.

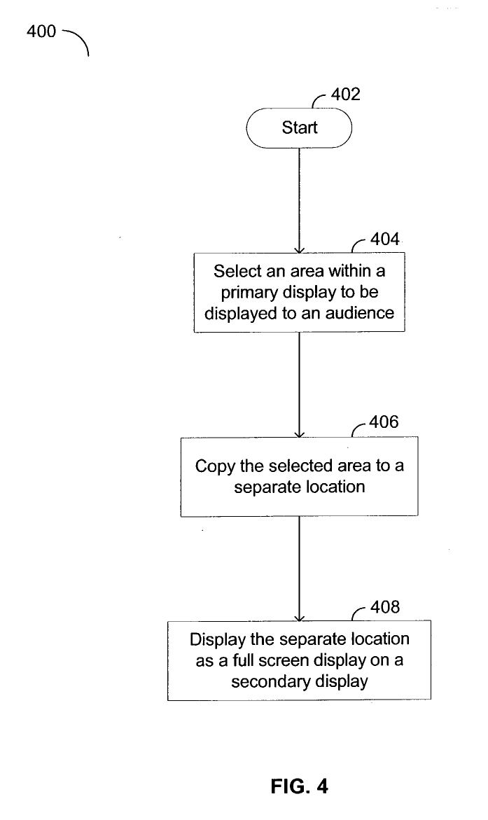

FIG. 4 is a flow diagram 400 describing a method for managing public and private information on a user's computer screen for display of the public information to others on a secondary display according to an embodiment of the present invention. The invention is not limited to the embodiment described herein with respect to flow diagram 400. Rather, it will be apparent to persons skilled in the relevant art(s) after reading the teachings provided herein that other functional flow diagrams are within the scope of the invention. The process begins with block 402, where the process immediately proceeds to block 404.

In block 404, the user selects an area of the primary display that is to be viewed by an audience on a secondary display. As previously indicated, three different modes are available to the user for segmenting the private and public data displayed on the user's computer screen, such as computer screen 104, to enable the display of the public data on the secondary display. For example, the user may select the entire desktop display for viewing by the audience using desktop capture mode button 304. The user may only want to select a specific window to display to the audience and, therefore, use window capture mode button 306. Alternatively, the user may want to display a region or area of the desktop display by dragging a bounded box around the area. This is accomplished when the user selects region capture mode button 308.

In an alternative embodiment, the user may want to display more than one window or area of the primary display. This may be accomplished by selecting region capture mode button 308 and/or window capture mode button 306. Also, the user is not restricted to using region capture mode button 308 and window capture mode button 306 one time. In fact, buttons 308 and 306 may be used several times to capture multiple regions or windows displayed on the primary display for viewing by the audience on the secondary display.

Once the public area to be viewed by the audience is selected, that area is copied to a separate display location in block 406. In one embodiment, the separate location may represent a secondary display window. For example, as shown in graphical user interface 300, the secondary display window is a projector setting window having display area 302. Although display area 302 is described as being the separate location for displaying information selected by the user, embodiments of the invention are not limited to display area 302. One skilled in the relevant art(s) will know that other separate locations may be used. For example, separate locations may include, but are not limited to, a location on a screen, a window location, a displayable memory location, etc.

The public area to be viewed by the audience is copied into display area 302. In one embodiment, a Share Ware program entitled MWSnap is used to copy the selected area into display area 302. In another embodiment, the selected area is dragged and dropped into display area 302. In yet another embodiment, a bit map copy is performed to place the selected area into display area 302.

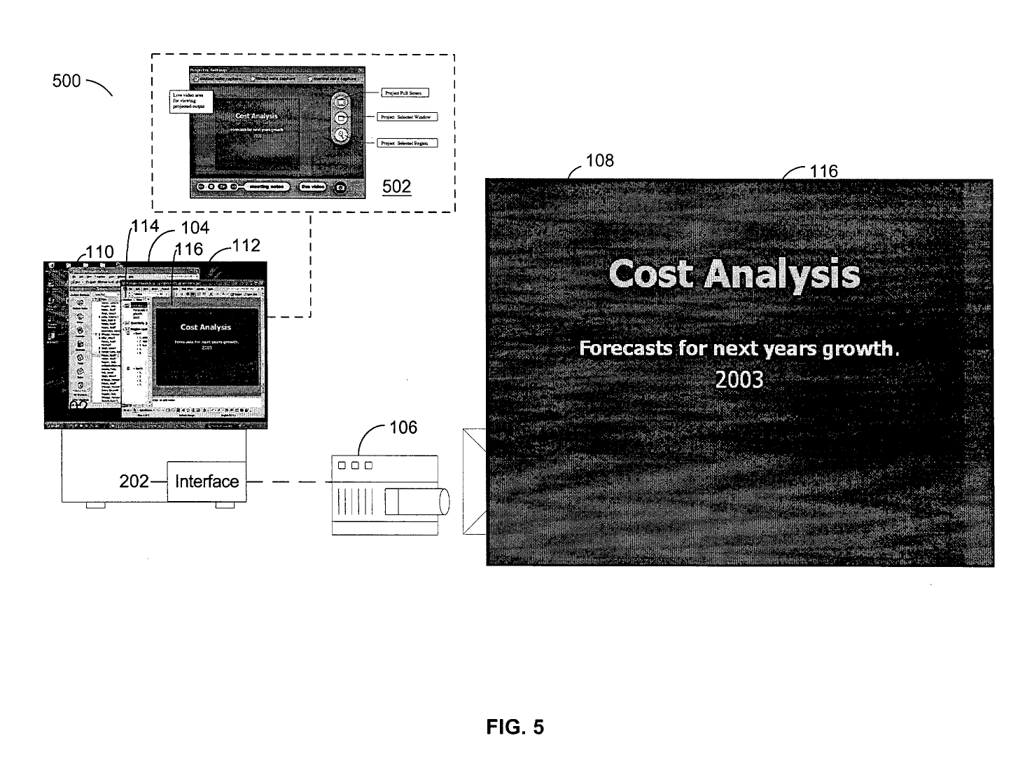

In block 408, the public information displayed within display area 302 is then rendered as a full screen display on the secondary display. For example, in FIG. 5, the selected area from computer screen 104 (the “Cost Analysis” presentation) is copied into display area 302 (shown in phantom as a separate location 502 displayed on computer screen 104), and the information within display area 302 is then rendered onto projector screen 108 via projector 106 as a full screen display for viewing by the audience.

In another embodiment of the present invention, interface 202 may be comprised of both hardware and software components. The software component selects the public information from the user's screen and copies the selected public information in a memory location. The hardware component reads the public information from memory and renders the public information onto a secondary screen for public consumption by an audience. In one embodiment, the hardware component may be, but is not limited to, a video controller.

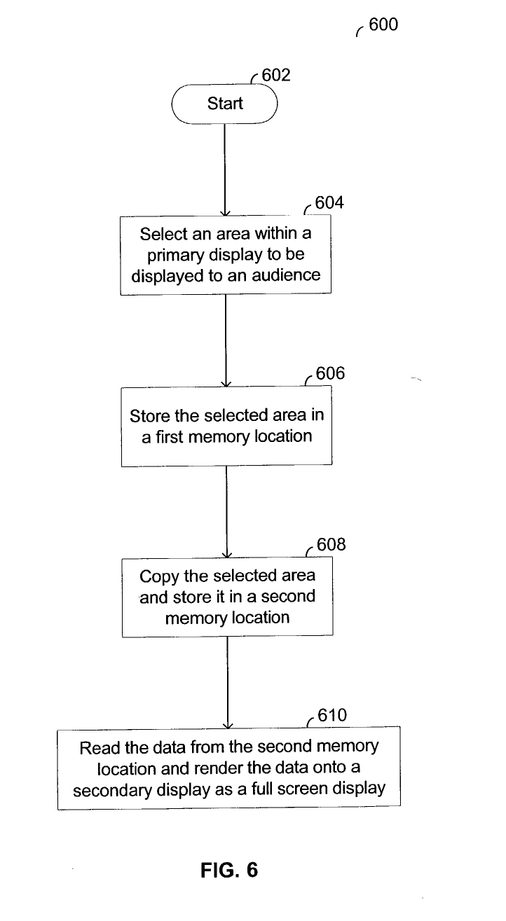

FIG. 6 is a flow diagram 600 describing an alternative method for managing public and private information on a user's computer screen for display of the public information to others on a secondary display according to an embodiment of the present invention. The invention is not limited to the embodiment described herein with respect to flow diagram 600. Rather, it will be apparent to persons skilled in the relevant art(s) after reading the teachings provided herein that other functional flow diagrams are within the scope of the invention. The process begins with block 602, where the process immediately proceeds to block 604.

In block 604, the user selects an area of the primary display that is to be viewed by an audience on a secondary display in a similar manner as described above with reference to block 404 in FIG. 4.

In one embodiment, the selected area may be stored in a first memory location (block 406). The first memory location may be system memory or memory on a graphics card from which the selected area may be displayed. In one embodiment, the selected area may be copied to a separate location for enabling the user to view the selected area as described above with reference to block 406 in FIG. 4.

In block 608, the selected area is copied and stored in a memory location that is accessible to a controller, such as a video controller.

In block 610, the video controller reads the selected area from memory and renders the selected area onto the secondary display for displaying the selected area as a full screen display.

In one embodiment, the selected area may be rendered to more than one secondary display, wherein one or more of the secondary displays are in remote locations. Also, in another embodiment, different areas of computer screen 104 may be selected for display in different locations. For example, a selected area #1 may be displayed in a location #1, a selected area #2 may be displayed in a location #2, etc. Such embodiments may be accomplished when computer 102 is connected to a network, such as, but not limited to, a local area network (LAN) or a wide area network (WAN).

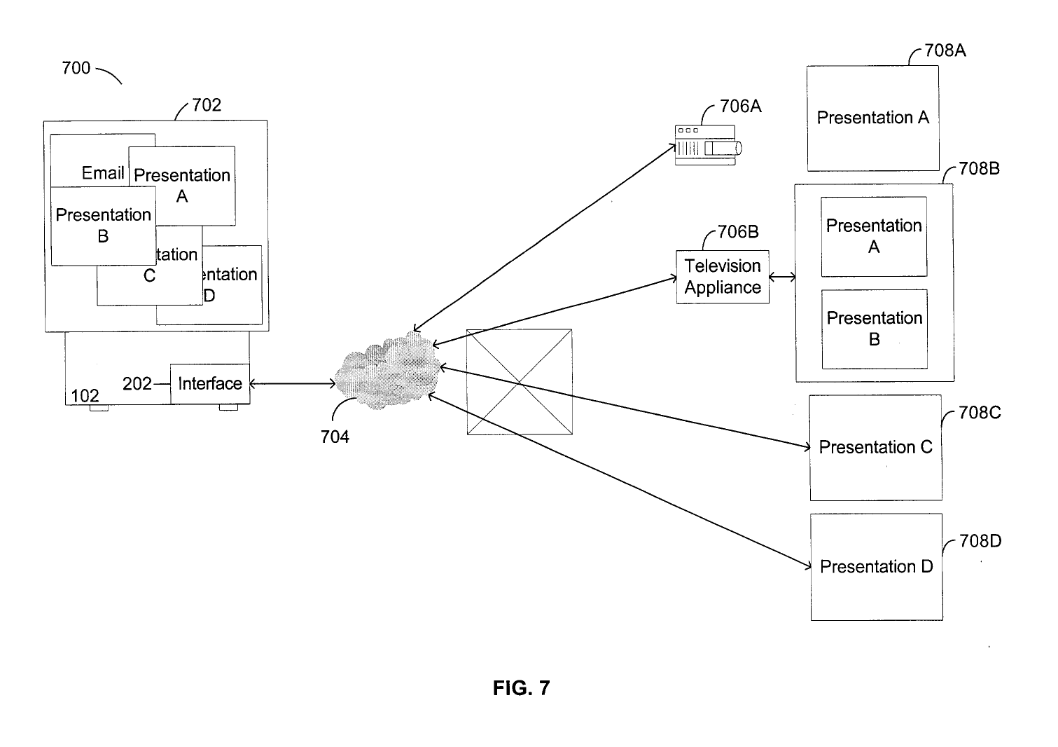

FIG. 7 is a block diagram illustrating an exemplary system 700 for managing public and private information on a user's computer screen for display of the public information to others over a network connection on a plurality of secondary displays according to an embodiment of the present invention. System 700 comprises desktop computer 102 with a computer screen 702, interface 202, a network 704, and a plurality of secondary displays 708A, 708B, 708C, and 708D. Desktop computer 102 may be connected to network 704 via Ethernet, fiber optic cable, serial cable, Bluetooth, wireless Ethernet, or any other connection means for connecting a computer to a network. Secondary display 708A is coupled to network 704 via a projector 706A.4 Secondary display 708A may be, but is not limited to, a projector screen. Secondary display 708B is coupled to network 704 via a television appliance, such as, but not limited to, a set-top box, a digital entertainment terminal, a cable box, etc. Secondary display 708B may be, but is not limited to, a large screen projection television. Projector 706A, television appliance 706B, and secondary displays 708C and 708D may be coupled to network 704 via Ethernet, fiber optic cable, serial cable, Bluetooth, wireless Ethernet, or any other well known connection means. Secondary displays 708C and 708D may be, but are not limited to, LCDs (liquid crystal displays) and/or plasma displays.

Computer screen 702 displays both private and public information. Private information displayed on computer screen 702 includes an Email window and public information displayed on computer screen 702 includes Presentation A, Presentation B, Presentation C, and Presentation D. Each of secondary displays 708A-708D is receiving one or more presentation windows from computer screen 702 over network 704. The private email information from screen 702 is hidden from the audiences viewing secondary displays 708A-708D.

As shown on secondary displays 708A, 708B, 708C, and 708D, the user of computer 102 has selected different public information for display on the different secondary displays (708A, 708B, 708C, and 708D). For example, on secondary display 708A, the user has selected Presentation A. On secondary display 708B, the user has selected Presentations A and B. On secondary display 708C, the user has selected Presentation C. And on secondary display 708D, the user has selected Presentation D.

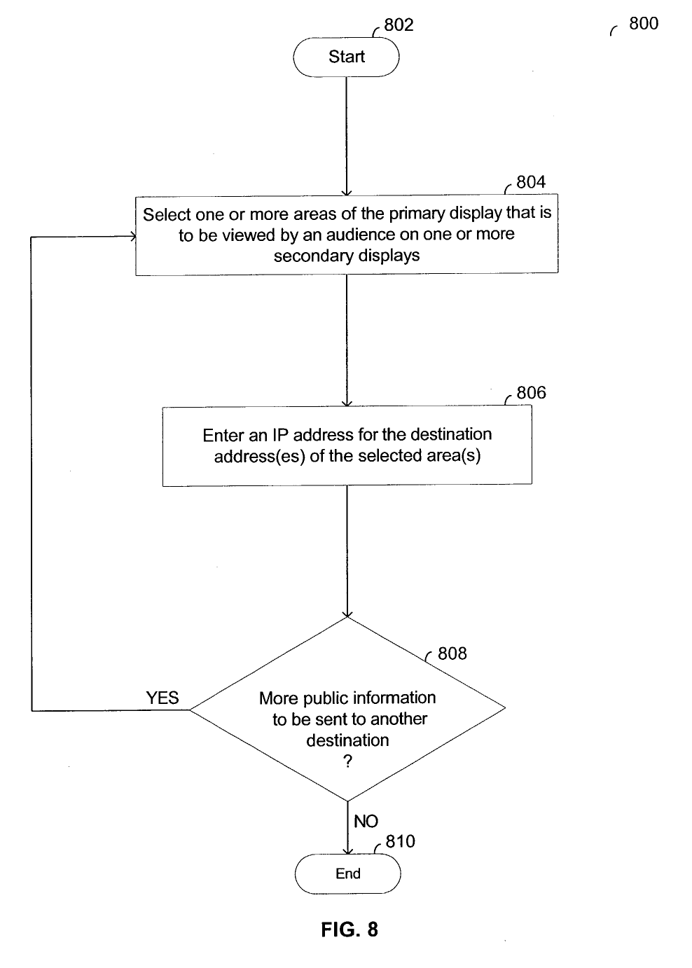

In order to provide selected public information to different secondary displays over network 704, the user must select a destination address indicating where the selected area (or areas) of the primary display are to be sent. Thus, selection blocks 404 and 606 in FIGS. 4 and 6 are further described with respect to exemplary flow diagram FIG. 8. The process begins with block 802, where the process immediately proceeds to block 804.

In block 804, the user may select one or more areas of the primary display that are to be viewed by audiences on one or more secondary displays. The user may select the areas using one or more of the three mode buttons (304, 306, and/or 308) as described above with reference to FIGS. 3 and 4.

In block 806, the user may enter or select an Internet Protocol (IP) address for the destination address of the area(s) selected in block 804. In one embodiment, frequently used IP addresses are stored as a pull down list for enabling the user to make a selection. The process then proceeds to decision block 808.

In decision block 808, it is determined whether public information is to be sent to another destination address. If public information is to be sent to another destination address, then the process returns to block 804 to allow the user to select the area(s) to be sent to the next destination location. If public information is not to be sent to another destination address, then the process proceeds to block 810, where the process ends.

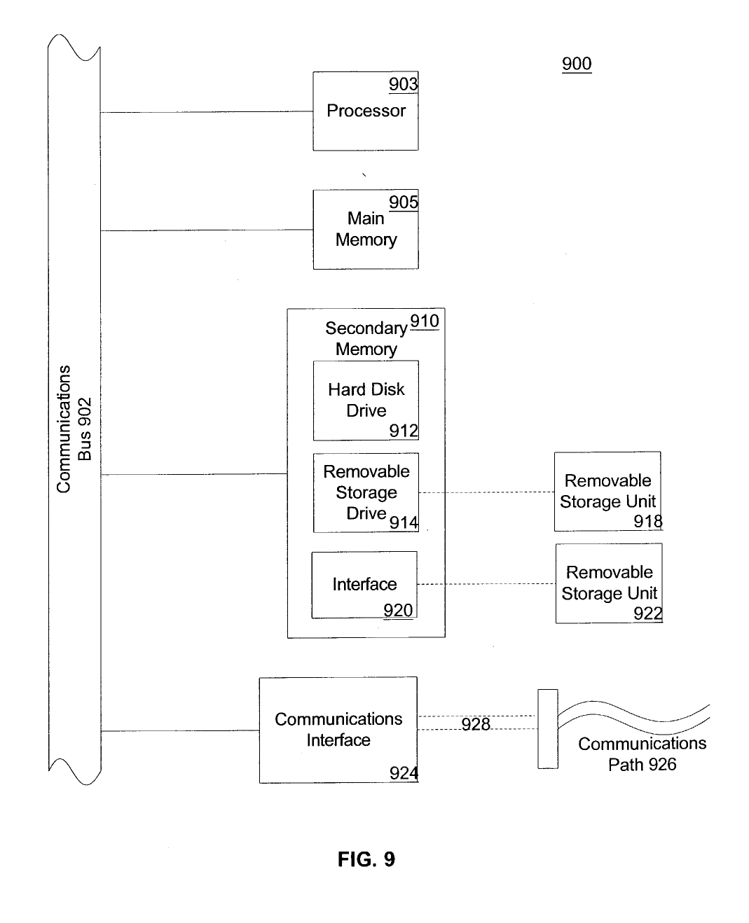

Embodiments of the present invention may be implemented using hardware, software, or a combination thereof and may be implemented in one or more computer systems or other processing systems. In fact, in one embodiment, the invention is directed toward one or more computer systems capable of carrying out the functionality described here. An example implementation of a computer system 900 is shown in FIG. 9. Various embodiments are described in terms of this exemplary computer system 900. After reading this description, it will be apparent to a person skilled in the relevant art how to implement the invention using other computer systems and/or computer architectures.

Computer system 900 includes one or more processors, such as processor 903. Processor 903 is connected to a communication bus 902. Computer system 900 also includes a main memory 905, preferably random access memory (RAM), and may also include a secondary memory 910. Secondary memory 910 may include, for example, a hard disk drive 912 and/or a removable storage drive 914, representing a floppy disk drive, a magnetic tape drive, an optical disk drive, etc. Removable storage drive 914 reads from and/or writes to a removable storage unit 918 in a well-known manner. Removable storage unit 918 represents a floppy disk, magnetic tape, optical disk, etc., which is read by and written to by removable storage drive 914. As will be appreciated, removable storage unit 918 includes a computer usable storage medium having stored therein computer software and/or data.

In alternative embodiments, secondary memory 910 may include other similar means for allowing computer programs or other instructions to be loaded into computer system 900. Such means may include, for example, a removable storage unit 922 and an interface 920. Examples of such may include a program cartridge and cartridge interface (such as that found in video game devices), a removable memory chip (such as an EPROM (erasable programmable read-only memory) or PROM (programmable read-only memory)) and associated socket, and other removable storage units 922 and interfaces 920 which allow software and data to be transferred from removable storage unit 922 to computer system 900.

Computer system 900 may also include a communications interface 924. Communications interface 924 allows software and data to be transferred between computer system 900 and external devices. Examples of communications interface 924 may include a modem, a network interface (such as an Ethernet card), a communications port, a PCMCIA (personal computer memory card international association) slot and card, a wireless LAN (local area network) interface, etc. Software and data transferred via communications interface 924 are in the form of signals 928 which may be electronic, electromagnetic, optical or other signals capable of being received by communications interface 924. These signals 928 are provided to communications interface 924 via a communications path (i.e., channel) 926. Channel 926 carries signals 928 and may be implemented using wire or cable, fiber optics, a phone line, a cellular phone link, a wireless link, and other communications channels.

In this document, the term “computer program product” refers to removable storage units 918, 922, and signals 928. These computer program products are means for providing software to computer system 900. Embodiments of the invention are directed to such computer program products.

Computer programs (also called computer control logic) are stored in main memory 905, and/or secondary memory 910 and/or in computer program products. Computer programs may also be received via communications interface 924. Such computer programs, when executed, enable computer system 900 to perform the features of the present invention as discussed herein. In particular, the computer programs, when executed, enable processor 903 to perform the features of embodiments of the present invention. Accordingly, such computer programs represent controllers of computer system 900.

In an embodiment where the invention is implemented using software, the software may be stored in a computer program product and loaded into computer system 900 using removable storage drive 914, hard drive 912 or communications interface 924. The control logic (software), when executed by processor 903, causes processor 903 to perform the functions of the invention as described herein.

In another embodiment, the invention is implemented primarily in hardware using, for example, hardware components such as application specific integrated circuits (ASICs). Implementation of hardware state machine(s) so as to perform the functions described herein will be apparent to persons skilled in the relevant art(s). In yet another embodiment, the invention is implemented using a combination of both hardware and software.

While various embodiments of the present invention have been described above, it should be understood that they have been presented by way of example only, and not limitation. It will be understood by those skilled in the art that various changes in form and details may be made therein without departing from the spirit and scope of the invention as defined in the appended claims. Thus, the breadth and scope of the present invention should not be limited by any of the above-described exemplary embodiments, but should be defined in accordance with the following claims and their equivalents.

What is claimed is:

1. A method for segregating display information, comprising:
enabling a user to select an area of a primary display to be viewed by an audience on a secondary display, wherein the primary display includes public and private information;
copying the selected area to a separate location; and
rendering the separate location to the secondary display,
wherein public information is shown on the secondary display.

2. The method of claim 1, wherein enabling a user to select an area of a primary display comprises at least one of enabling the user to select an entire desktop, enabling the user to select a specific window in the desktop, and enabling a user to select a region within the desktop.

3. The method of claim 1, wherein copying the selected area to a separate location comprises dragging and dropping the selected area into the separate location.

4. The method of claim 1, wherein copying the selected area to a separate location comprises bit map copying the selected area into the separate location.

5. The method of claim 1, wherein the separate location comprises a display area for enabling the user to view the public information to be rendered onto the secondary display.

6. The method of claim 1, wherein the primary display comprises one of a desktop monitor and a laptop monitor.

7. The method of claim 1, wherein the secondary display comprises at least one of a projector screen, a projection television, a television, a computer monitor, a plasma display, and a liquid crystal display (LCD).

8. An article comprising: a storage medium having a plurality of machine accessible instructions, wherein when the instructions are executed by a processor, the instructions provide for enabling a user to select an area of a primary display to be viewed by an audience on a secondary display, wherein the primary display includes public and private information;
copying the selected area to a separate location; and
rendering the separate location to the secondary display, wherein public information is shown on the secondary display.

9. The article of claim 8, wherein instructions for enabling a user to select an area of a primary display comprises instructions for at least one of enabling the user to select an entire desktop, enabling the user to select a specific window in the desktop, and enabling a user to select a region within the desktop.

10. The article of claim 8, wherein instructions for copying the selected area to a separate location comprises instructions for dragging and dropping the selected area into the separate location.

11. The article of claim 8, wherein instructions for copying the selected area into a separate location comprises instructions for bit map copying the selected area into the separate location.

12. The article of claim 8, wherein the separate location comprises a display area for enabling the user to view the public information to be rendered onto the secondary display.

13. The article of claim 8, wherein the primary display comprises one of a desktop monitor and a laptop monitor.

14. The article of claim 8, wherein the secondary display comprises at least one of a projector screen, a projection television, a television, a computer monitor, a plasma display, and a liquid crystal display (LCD).

15. A method for segregating display information comprising:
enabling a user to select an area of a primary display to be viewed by an audience on a secondary display, wherein the primary display includes public and private information;
storing the selected area in a memory location;
retrieving the selected area from the memory location; and
rendering the selected area from the memory location onto the secondary display.

16. The method of claim 15, wherein enabling a user to select an area of a primary display comprises at least one of enabling the user to select an entire desktop, enabling the user to select a specific window in the desktop, and enabling a user to select a region within the desktop.

17. The method of claim 15, further comprising:
storing the selected area in an initial memory location; and
copying the selected area stored in the initial memory location into a separate location to allow the user to view the selected area.

18. The method of claim 17, wherein the separate location comprises a display area for viewing the public information to be rendered onto the secondary display.

19. The method of claim 15, wherein the primary display comprises one of a desktop monitor and a laptop monitor.

20. The method of claim 15, wherein the secondary display comprises at least one of a projector screen, a projection television, a television, a computer monitor, a plasma display, and a liquid crystal display (LCD).

21. An article comprising: a storage medium having a plurality of machine accessible instructions, wherein when the instructions are executed by a processor, the instructions provide for enabling a user to select an area of a primary display to be viewed by an audience on a secondary display, wherein the primary display includes public and private information;
storing the selected area in a memory location;
retrieving the selected area from the memory location; and
rendering the selected area from the memory location onto the secondary display.

22. The article of claim 21, wherein instructions for enabling a user to select an area of a primary display comprises instructions for at least one of enabling the user to select an entire desktop, enabling the user to select a specific window in the desktop, and enabling a user to select a region within the desktop.

23. The article of claim 21, further comprising instructions for storing the selected area in an initial memory location; and
copying the selected area stored in the initial memory location into a separate location to allow the user to view the selected area.

24. The article of claim 23, wherein the separate location comprises a display area for viewing the public information to be rendered onto the secondary display.

25. The article of claim 21, wherein the primary display comprises one of a desktop monitor and a laptop monitor.

26. The article of claim 21, wherein the secondary display comprises at least one of a projector screen, a projection television, a television, a computer monitor, a plasma display, and a liquid crystal display (LCD).

27. A method for segregating display data comprising:
enabling a user to select one or more areas of a primary display to be viewed by audiences on one or more secondary displays, wherein the primary display includes public and private information;
enabling a user to enter one or more destination addresses representing each of the one or more secondary displays in which the selected areas are to be sent;
copying the one or more selected areas to a separate location;
piping the separate location over a network connection to the one or more secondary displays based on the one or more destination addresses; and
rendering the separate location to the one or more secondary displays based on the one or more destination addresses,
wherein public information is shown on the one or more secondary displays.

28. The method of claim 27, wherein enabling a user to select one or more areas of a primary display to be viewed by audiences on one or more secondary displays comprises one or more of enabling the user to select an entire desktop, enabling the user to select one or more specific windows in the desktop, and enabling a user to select one or more regions within the desktop.

29. The method of claim 27, wherein different selected areas are rendered to different secondary displays based on the destination addresses.

30. The method of claim 27, wherein the separate location comprises a display area for enabling the user to view the public information to be rendered onto the secondary display.

31. The method of claim 27, wherein the primary display comprises one of a desktop monitor and a laptop monitor.

32. The method of claim 27, wherein the secondary display comprises at least one of a projector screen, a projection television, a television, a computer monitor, a plasma display, and a liquid crystal display (LCD).

33. An article comprising: a storage medium having a plurality of machine accessible instructions, wherein when the instructions are executed by a processor, the instructions provide for enabling a user to select one or more areas of a primary display to be viewed by audiences on one or more secondary displays, wherein the primary display includes public and private information;
enabling a user to enter one or more destination addresses representing each of the one or more secondary displays in which the selected areas are to be sent;
copying the one or more selected areas to a separate location;
piping the separate location over a network connection to the one or more secondary displays based on the one or more destination addresses; and
rendering the separate location to the one or more secondary displays based on the one or more destination addresses,
wherein public information is shown on the one or more secondary displays.

34. The article of claim 33, wherein instructions for enabling a user to select one or more areas of a primary display to be viewed by audiences on one or more secondary displays comprises instructions for one or more of enabling the user to select an entire desktop, enabling the user to select one or more specific windows in the desktop, and enabling a user to select one or more regions within the desktop.

35. The article of claim 33, wherein different selected areas are rendered to different secondary displays according to the destination addresses.

36. The article of claim 33, wherein the separate location comprises a display area for enabling the user to view the public information to be rendered onto the secondary display.

37. The article of claim 33, wherein the primary display comprises one of a desktop monitor and a laptop monitor.

38. The article of claim 33, wherein the secondary display comprises at least one of a projector screen, a projection television, a television, a computer monitor, a plasma display, and a liquid crystal display (LCD).

39. A system for segregating display data, comprising:
a computing device, the computing device including a primary display comprising public and private information;
an interface coupled to the computing device; and
a secondary display coupled to the interface;
wherein the interface enables a user to select public information from the primary display, copy the selected public information to a separate location displayed on the primary display, and render the separate location onto the secondary display for display of the selected public information to an audience.

40. The system of claim 39, wherein the secondary display comprises a projector screen, the system further comprising a projector for projecting the rendered separate location onto the projector screen.

41. The system of claim 39, wherein the secondary display comprises a television appliance, the system further comprising a projection television for projecting the rendered separate location onto the projection television.

42. The system of claim 39, wherein the secondary display comprises one of a projector screen, a projection television, a television, a computer monitor, a plasma display, and a liquid crystal display (LCD).

43. The system of claim 39, wherein the computing device comprises one of a desktop and a laptop computer and the primary display comprises one of a desktop and a laptop monitor.

44. The system of claim 39, wherein the interface is located within the computing device.
